(19) United States
(12) Patent Application Publication
(10) Pub. No.: US 2021/0095715 A1
(43) Pub. Date: Apr. 1, 2021

(54) JOINT ASSEMBLY FOR MOTION SIMULATOR

(71) Applicant: D-BOX TECHNOLOGIES INC., Longueuil (CA)

(72) Inventors: Stephan GAGNON, Rosemere (CA); Jean-Francois MENARD, Longueuil (CA)

(21) Appl. No.: 16/499,530

(22) PCT Filed: Mar. 28, 2018
(86) PCT No.: PCT/CA2018/050381

§ 371 Date: Sep. 30, 2019

Related U.S. Application Data
(60) Provisional application No. 62/479,129, filed on Mar. 30, 2017.

(51) Int. Cl. F16C 19/06; F16C 19/54; G09B 9/12; F16C 27/06

(52) U.S. Cl. CPC F16C 19/06; F16C 19/542; F16C 19/12; F16C 27/066; G09B 9/12

(57) ABSTRACT

A joint assembly comprises a rotational joint member configured to be connected to a first component. A housing is configured to be connected to a second component or ground and defining an inner cavity. A translating member is received in the inner cavity of the housing and connected to the rotational joint member for concurrent translation relative to the housing. One or more levels of balls in the inner cavity between a housing surface and a surface of the translating member to support the translation of the translating member in the housing. A motion simulator featuring one or more of the joint assemblies is also provided.

### CROSS-REFERENCE TO RELATED APPLICATION

The present application claims the priority of U.S. Provisional Patent Application No. 62/479,129, filed on Mar. 30, 2017 and incorporated herein by reference.

### TECHNICAL FIELD

The present application relates to joint assemblies of the type used in motion simulators.

### BACKGROUND OF THE ART

Motion simulators commonly feature a seat, platform or passenger compartment, supported by actuated legs so as to be displaceable as a function of actuation from actuators in the actuated legs. The actuated legs are mounted to the ground/floor, or to a structure at one end, and to the motion platform or seat at the other end. Spherical joints are commonly used in the actuated legs of motion simulators as they enable multiple degrees of freedom of rotation between parts they join. However, due to the multiple forces involved in the actuation of motion simulators, the actuated legs may be subjected to lateral loads. Therefore, actuated legs, for instance of the type having their opposed ends respectively anchored to the motion platform or seat and to a structure, may include passive translation joints to avoid damaging the spherical joints. However, passive translation joints often rely on sliding movements between two flat surfaces, which may be inefficient and may expose components of the actuated legs to stresses from the lateral loads.

### SUMMARY

It is an aim of the present disclosure to provide a joint assembly that addresses issues associated with the prior art.

Therefore, in accordance with a first embodiment of the present disclosure, there is provided a joint assembly comprising: a rotational joint member configured to be connected to a first component; a housing configured to be connected to a second component or ground and defining an inner cavity; a translating member received in the inner cavity of the housing and connected to the rotational joint member for concurrent translation relative to the housing; and at least one level of balls in the inner cavity between a housing surface and a surface of the translating member to support the translation of the translating member in the housing.

Further in accordance with the embodiment, the housing has for instance at least a first body and a second body, at least one of the bodies having a depression to form at least part of the inner cavity.

Still further in accordance with the embodiment, each of the bodies has for instance one of the depression.

Still further in accordance with the embodiment, the depression is for instance annular.

Still further in accordance with the embodiment, the first body has for instance a collar projecting into the inner cavity, the collar forming for instance a central bore for accessing the translating member via an exterior of the housing.

Still further in accordance with the embodiment, the rotational joint member has for instance a rod connected to the translating member and projecting out of the housing via a central bore in the second body.

Still further in accordance with the embodiment, the rod is for instance connected to the translating member by a fastener, the fastener being accessible from the central bore in the collar.

Still further in accordance with the embodiment, the first body and the second body have for instance pairs of tapped hole and fastener hole for receiving fasteners to secure the first body and the second body to one another.

Still further in accordance with the embodiment, the pairs of tapped hole and fastener hole include for instance a cylindrical neck and corresponding counter shape for mating engagement.

Still further in accordance with the embodiment, at least one throughbore extends for instance through the housing and is for instance adapted to receive a fastener for securing the housing to the second component or ground.

Still further in accordance with the embodiment, the translating member has for instance a plate body received in the housing, the plate body defining said surface of the translating member.

Still further in accordance with the embodiment, the plate body is for instance a disc.

Still further in accordance with the embodiment, the plate body has for instance a peripheral flange.

Still further in accordance with the embodiment, at least three biasing assemblies are for instance in the inner cavity, the biasing assemblies each exerting a combined force oriented to toward a center of the housing on the translating member.

Still further in accordance with the embodiment, the biasing assemblies are for instance equidistantly distributed in the housing.

Still further in accordance with the embodiment, the biasing assemblies each include for instance a spring and a ball.

Still further in accordance with the embodiment, the biasing assemblies are for instance each received in a respective slot in the housing.

Still further in accordance with the embodiment, the respective slots are for instance radially oriented in the housing.

Still further in accordance with the embodiment, two of said levels of balls are for instance provided, with a first of said levels of balls between a first of the housing surface and a first of the surface of the translating member, and with a second of said levels of balls for instance between a second of the housing surface and a second of the surface of the translating member.

Still further in accordance with the embodiment, the level of balls is for instance a ball bearing including a plurality of balls and a ring holding the balls.

Still further in accordance with the embodiment, the rotational joint member is for instance a spherical joint.

Still further in accordance with the embodiment, the spherical joint has for instance a ball immovably connected to the translating member by a rod extending from the translating member in the inner cavity to the ball.

Still further in accordance with the embodiment, an axis of the rod is for instance normal to a plane of translation of the translating member.

Still further in accordance with the embodiment, a spherical joint housing is for instance operatingly connected to the ball for forming said spherical joint.

Still further in accordance with the embodiment, a threaded rod projects for instance from the spherical joint housing and adapted to be connected to the first component.

Still further in accordance with the embodiment, there is provided for instance a motion simulator comprising: a motion platform adapted to support at least one user; at least one linear actuator or cylinder; and the joint assembly as described above to interface the at least one linear actuator or cylinder to the motion platform or to the ground or base structure.

Still further in accordance with the embodiment, the joint assembly is for instance between the at least one linear actuator or cylinder and the ground or base structure.

### DESCRIPTION OF THE DRAWINGS

FIG. 1 is a perspective view of a motion simulator using joint assemblies in accordance with the present disclosure;

FIG. 2 is a perspective view of a joint assembly of the present disclosure;

FIG. 3 is an exploded view of the joint assembly of FIG. 2, from a linear actuator side, in accordance with a first embodiment;

FIG. 4 is an exploded view of the joint assembly of FIG. 2, from a structure side, in accordance with the first embodiment;

FIG. 5 is a perspective view showing a translating member relative to a body of a housing, in the joint assembly of FIG. 2;

FIG. 6 is a longitudinal cross-sectional view of the joint assembly of FIG. 2;

FIG. 7 is an exploded view of the joint assembly of FIG. 2 from a linear actuator side, in accordance with a second embodiment; and

FIG. 8 is an exploded view of the joint assembly of FIG. 2; from a structure side, in accordance the second embodiment.

### DETAILED DESCRIPTION

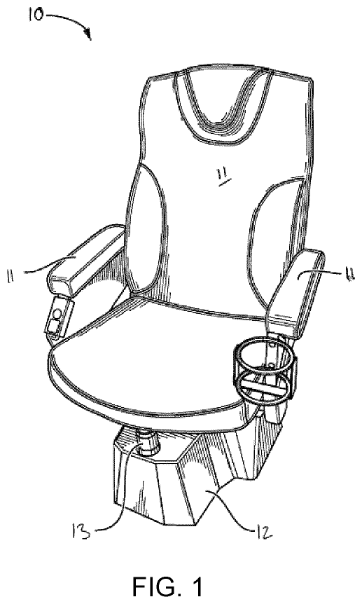

Referring to drawings and, more particularly, to FIG. 1, there is illustrated a motion simulator at 10. The motion simulator 10 is of the type that may receive actuation signals from a controller so as to move an output thereof in accordance with a set of movements, and perform vibro-kinetic effects at the output. For example, the motion simulator 10 may be of the type that moves in synchronicity with video or audio output, with motion signals representative of movements to be performed being received from a controller. In the illustrated embodiment, the motion simulator 10 has a motion platform 11 supporting one or more occupants exposed to movements of the motion simulator 10. In the illustrated embodiment, the motion platform 11 is a seat having a seat portion in which a user may be seated. Other occupant supporting structures may be included, but for simplicity the expression seat portion 11 will be used in the present application.

The seat portion 11 is shown as having armrests, a seat, and a backrest and this is one of numerous configurations considered, as the seat portion 11 could be for a single user, multiple users, may be a bench, a cockpit, etc. The motion simulator 10 also has an actuation system 12 by which the output, namely the seat portion 11, is supported to the ground. The actuation system 12 is shown as having a casing hiding its various components, although an actuated leg 13 is partly visible. The actuation system may have one or more of these actuated legs 13, supporting the output, i.e., the seat portion 11, from the ground. In an embodiment, the actuated leg 13 includes an electro-mechanical actuator of the type having a ball-screw system, although other types of linear actuators may be used. Alternatively, a hydraulic or pneumatic cylinder could be used in lieu of the electro-mechanical linear actuator, for the motion simulator 10. The motion simulator 10 of FIG. 1 is one among numerous possible configurations for the motion simulator. For example, the motion simulator 10 may support a platform, cockpit or structure instead of a seat portion, in a flight simulator embodiment, a cabin in a vehicle simulator embodiment or an end effector in the case of a parallel manipulator or like robotic application.

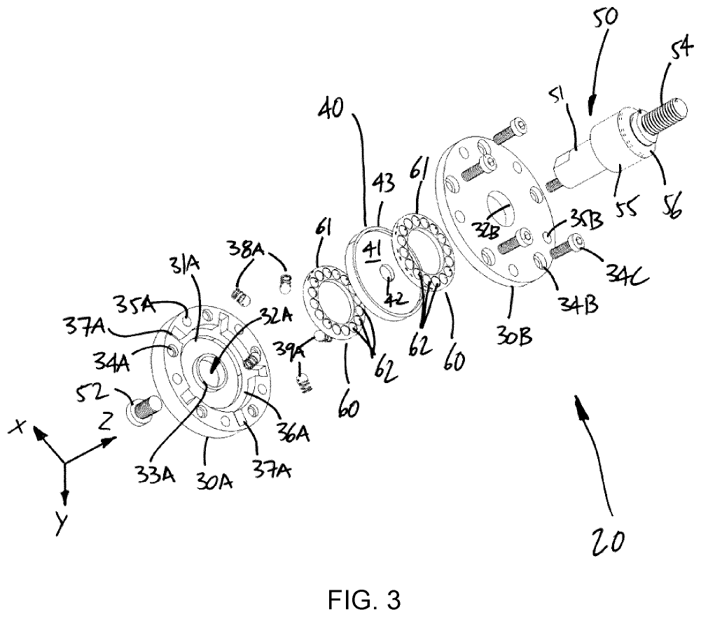

One or more of the actuated legs 13 may have a joint assembly 20 as shown in FIG. 3 to be connected to the ground or to the seat portion 11 by way of appropriate fasteners. In an embodiment, the joint assembly 20 is positioned on the ground. It is, however, contemplated to provide this joint assembly 20 against the underside of the seat portion 11 or like output of the motion simulator 10, as in FIG. 1.

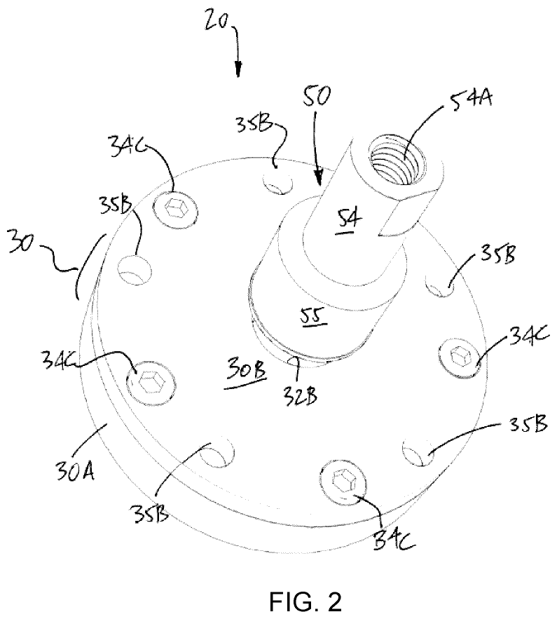

Referring to FIGS. 2-4, the joint assembly 20 may have a housing 30, a translating member 40, a rotational joint member 50, and one or more ball bearings 60:
The housing 30 may be present in the joint assembly 20 to secure it to an underside of the motion platform 11, or to the ground.
The translating member 40 is received in the housing 30, and therefore operatively connects the rotational joint member 50 to the housing 30. The translating member 40 may also form a translational joint with the housing 30, enabling one or two translational degrees of freedom (DOF) of movement as described hereinafter.
The rotational joint member 50 provides two or more rotational degrees of freedom to the joint assembly 20, such as pitch and roll (i.e., about axes X and Y). The yaw (i.e., the rotation about axis Z) may be provided by the rotational joint member 50 and/or by the assembly of the housing 30, the translating member 40 and the ball bearing(s) 60. The rotational joint member 50 may secure the joint assembly to a linear actuator or cylinder of the actuated leg 13.
The ball bearing(s) 60 support the translating movement of the translating member 40 in the housing 30.

Referring concurrently to FIGS. 2, 3 and 4, the housing 30 is shown as having a pair of bodies 30A and 30B. For simplicity, the like components of the bodies 30A and 30B may be concurrently referred to below without “A” or “B” affixed to them, but are shown in the Figures with the “A” or “B” to indicate whether they are components of the body 30A or the body 30B. The bodies 30A and 30B each have a depression 31. In the illustrated embodiment, the depressions 31 are circular in outer periphery, as a function of the peripheral shape of the translating member 40, and may form an annular shape and be regarded as annular depressions or annular channels. However, other shapes are considered. The depressions 31 concurrently define at least a part of an inner cavity of the housing 30, in which the translating member 40 and the ball bearing(s) 60 are housed. The depressions 31 may for example be cast, machined or printed as part of the housing 30. Alternatively, the housing 30 may be without the depressions 31. For example, the housing 30 could have two plates with an annular wall or ring separating the two plates and creating an inner volume of the housing 30. This is one of numerous possible embodiments.

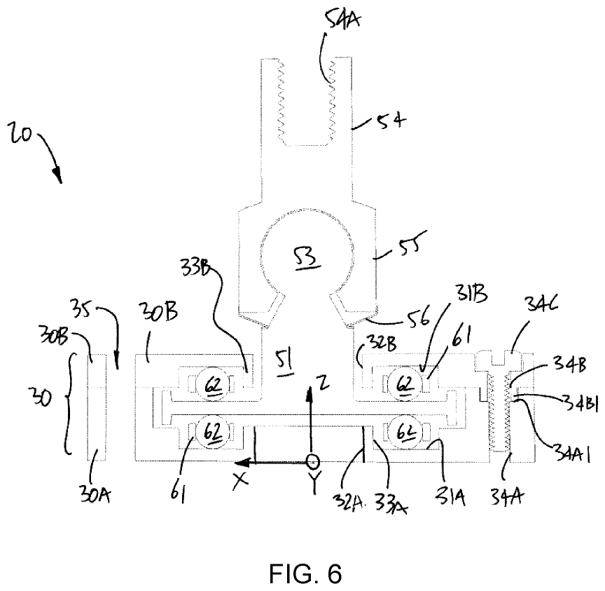

The bodies 30A and 30B each have a central bore 32. In the illustrated embodiment, the central bores 32 have a circular shape, but may have other shapes such as oval, squircle, rectangular, etc. The central bore 32A is provided to allow access to a fastener joining the rotational joint member 50 to the translating member 40. The central bore 32B allows the rotational joint member 50 to project out of the translating member 40 and therefore has a diameter greater than that of a rod of the rotational joint member 50 to allow translation of the translating member 40. This is for example shown in FIG. 6. Each central bore 32 may be surrounded by a collar 33. The collars 33 may delimit the range of movement of the ball bearing(s) 60 and/or ensure that balls of the ball bearing(s) 60 remain in the housing 30.

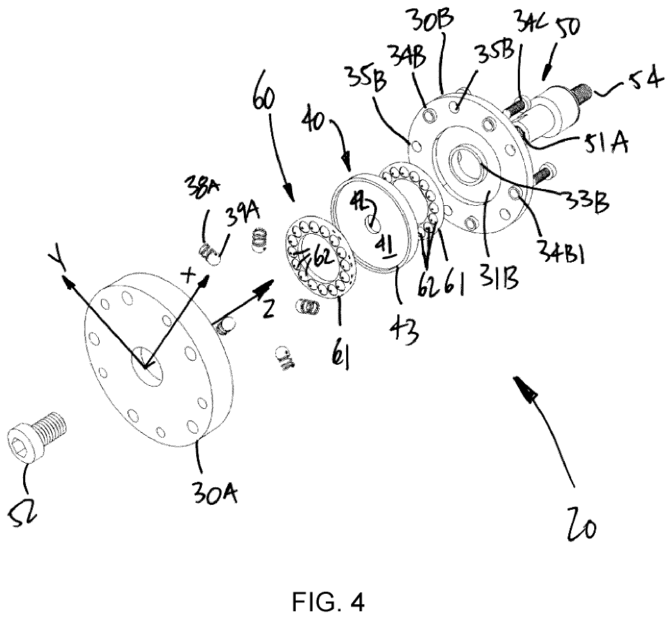

The body 30A may have tapped bores 34A, i.e., bores with internal threading. The body 30B has fasteners bores 34B, such as counterbores or countersink bores, without or with internal threading. The reverse arrangement is also possible, with the tapped bores being in the body 30B. It is also contemplated to have a mix of tapped bores and fastener bores in both of the bodies 30A and 30B. The bores 34 of the bodies 30A and 30B are circumferentially distributed and are in register with one another. Accordingly, fasteners 34C may be used to fasten the bodies 30 together, in the manner shown in FIG. 2. Other arrangements are considered as well, such as using bolts and nuts instead of tapped bores 34A. Also, as observed from FIGS. 4 and 6, cylindrical necks 34B1 may project from the fastener bores 34B to be received in corresponding countersinks 34A1 (or like counter shape) in the tapped bores 34A, to add other structures against shearing actions between the bodies 30A and 30B. The necks 34B1 are matingly and complementarily received in the countersinks 34A1. Other mating protrusions or surfaces may be present, not necessarily related to the bores 34.

Fixation bores 35 are circumferentially distributed in the bodies 30A and 30B, with the fixation bores 35 being in register to form throughbores extending from side to side of the housing 30 along axis Z, for connection of the housing 30 to an underside of the motion platform 11 or to the ground or base structure, or other component, using fasteners such as bolts. Although not shown, counterbores, countersinks, etc, may be defined in the fixation bores 35. Alternatively, a fastener head may rest against an outer surface of the body 30B.

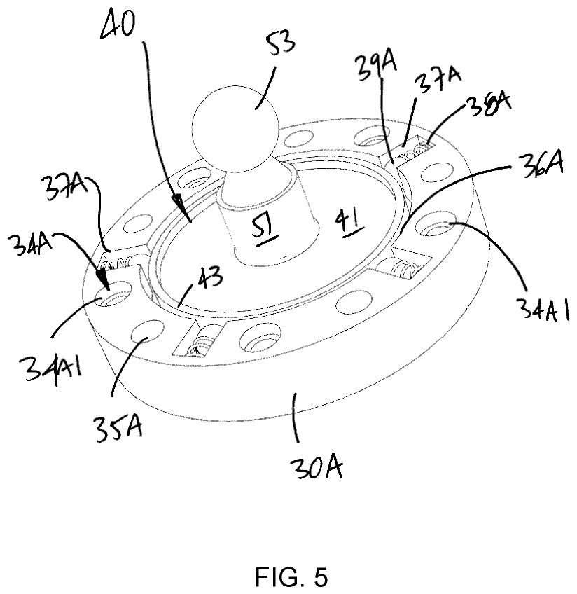

The body 30A may have additional features, as best seen in FIGS. 3 and 5. The body 30A may have a shoulder 36A (a.k.a., wall, step) surrounding the depression 31A. The shoulder 36A consequently also forms part of the inner cavity of the housing 30. The shoulder 36A is sized to receive therein a periphery of the translating member 40, as shown in FIGS. 5 and 6. A diameter of the wall delimiting the shoulder 36A has a greater diameter, to allow translational movement of the translating member 40 in the plane parallel to the vectors of axes X and Y. Slots 37A open into the inner cavity of the housing 30. Five slots 37A are shown, but the housing 30 could feature three or more of the slots 37A. In an embodiment, the slots 37A are equidistantly spaced from one another. In an embodiment, the slots 37A are radially oriented relative to a center of the body 30A. The slots 37A may therefore each accommodate a biasing assembly, such as springs 38A and balls 39A. The biasing assemblies are tasked with centering the translating member 40 in the inner cavity of the housing 30. Although the arrangement of shoulder 36A and slots 37A are described as being part of a single one of the bodies, namely body 30A, the body 30B could mirror the body 30A to jointly form these features.

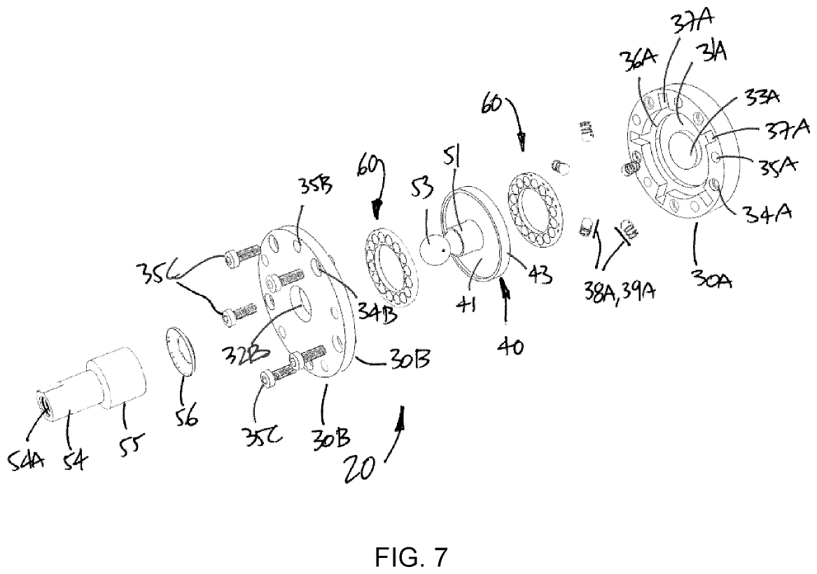

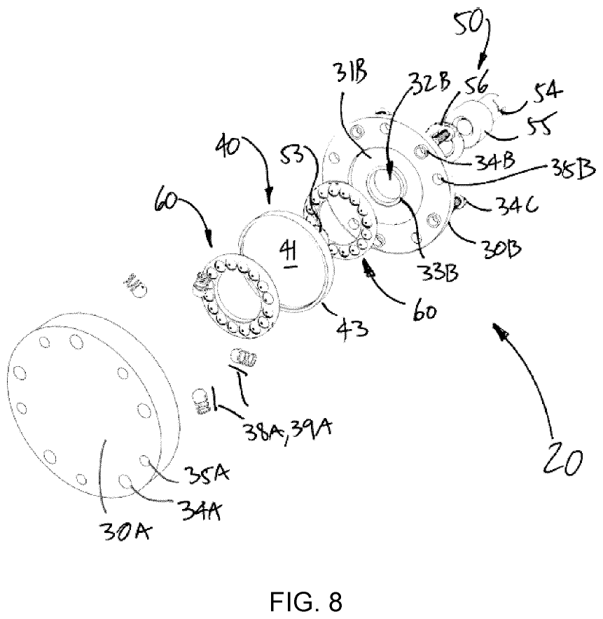

Referring to FIGS. 3-5, the translating member 40 may have a plate body 41. The plate body 41 is disc shaped, but other shapes are considered as well. The plate body 41 may have a central bore 42, to be releasably connected to the rotation joint member 50. Alternatively, as described in FIGS. 7 and 8, the plate body 41 may be integrally connected to a rod of the rotational joint assembly 50, for instance by welding or by a monolithic construction. A peripheral flange 43 may surround the translating member 40. As shown in FIG. 5, the balls 39A of the biasing assemblies apply a pressure on the circumference of the translating member 40. The peripheral flange 43, if present, defines the abutment surface by which the balls 39A press against translating member 40. Alternatively, the balls 39A may press against a peripheral surface of the translating member 40 if there is no flange 43 (with suitable thickness to the body 41). The equidistant distribution of the biasing assemblies generally results in a common centering effect to assist in having the translating member 40 reach a central position when possible. Although the biasing assemblies are shown as having coil springs 38A and balls 39A, other arrangements are contemplated. For example, the balls 39A may be replaced with low-friction pads, or the springs 38A could apply a biasing force directly on the translating member 40. Moreover, the housing 30 could be without the biasing assemblies. However, the balls 39A may conveniently roll relative to the springs 38A for negligible friction therebetween.

Accordingly, as shown in FIG. 5, the translating member 40 may be received in the space bound by the depressions 31 and the shoulder 36A, namely the inner cavity of the housing 30. The dimension of the translating member 40 is such that it is held captive in the housing 30, yet may move in a plane parallel to the surfaces of the depressions 32 and hence in up to two translational DOFs, and in a roll rotational DOF, i.e., the plane incorporating axes X and Y. The slots 37A are sized to ensure that the biasing assemblies remain captive even if the body 30B is removed, as in FIG. 5, to facilitate assembly and maintenance.

Referring to FIGS. 3 and 4, the rotational joint member 50 is shown as having a rod 51 by which it may be connected to the translating member 40 by way of a fastener 52 received in its tapped bore 51A. The rod 51 may hence have flats for a wrench or similar tool to be used to tighten the rod 51 to the translating member 40. Alternatively, as in FIGS. 7 and 8, the rod 51 may be integrally connected to the plate body 41, as an integral part. In an embodiment, the plate body 41 and the rod 51 are a monolithic piece. A ball 53 is at the end of the rod 51. The rod 51 and ball 53 may also be separate or integrally connected, for instance, by being a monolithic piece. For example, an end of the rod 51 may be screwed directly into a tapped bore of the ball 53. It is also observed that the ball 53 is not a full ball, notably because it is truncated at the junction with the rod 51. Nonetheless, the expression ball 53 is known to encompass ball portions (as opposed to a complete ball) or substantially spherical protuberance or protuberances.

The rotational joint member 50 may also have a second rod 54 by which it is connected to a linear actuator or cylinder. The rod 54 may for example be threaded as in FIG. 3, or have a tapped bore as in FIGS. 6 and 7 to be connected to the linear actuator, cylinder or to any other components in accordance with the set-up of the joint assembly 20. A ball housing 55 is at the end of the rod 54 facing the ball 53 (FIG. 6), and accommodates the ball 53 to form a spherical joint therewith. A washer 56 may cover the entry of the ball housing 55, and protect the spherical joint from infiltration of airborne particles, etc. The washer 56 may consist of a rubbery material in an embodiment. In FIG. 6, the spherical joint is shown schematically, but some arrangement must be provided for the ball 53 to be lodged into the ball housing 55. In the illustrated embodiment, the ball 53 is on the side of the translating member 40, whereas the ball housing 55 is on the side of the linear actuator or cylinder, but the reverse arrangement is possible as well. According to an embodiment, the rotational joint member 50 with spherical joint is an off-the-shelf device, that may be connected to the translating member 40 in the manner described above. Also, although a spherical joint is shown as the exemplary embodiment of the rotational joint member 50, the joint assembly 20 may feature other types of joints such as a universal joint (i.e., a cardan joint used as rotational joint member 50), provided sufficient rotational DOFs are present as a function of the use of the motion simulator 10 featuring the joint assembly 20.

Referring to FIGS. 3, 4 and 6, the ball bearings 60 are shown. The ball bearings 60 may feature a plurality of balls 62 retained by a ring 61. The ring 61 retains the balls 62 in a circumferential distribution while allowing rotations of the balls 62. For example, the ring 61 is made of a rigid low-friction polymer, while the balls 62 are metal balls. The assembly of balls 62 and ring 61 therefore facilitates handling, as a single component includes all balls 62. The ball bearings 60 are positioned between the translating member 40 and the depressions 31 (if present) or inner cavity of the housing 30. However, the ball bearings 60 may be free to move in translation directions parallel to the X-Y plane. The ball bearings 60 may also rotate about axis Z, allowing the roll of the translating member 40 relative to the housing 30. Moreover, instead of having the balls 62 rolling directly on the housing surface 30, a rolling plate may be added between the balls 62 and the housing surface 30, the rolling plate having a surface finish that could be more precisely controlled.

For the practical reasons defined above, the ball bearings 60 may include the rings 61 (e.g., one for each ball bearing 60). The rings 61 retain the balls 62 in position, but allow the balls 62 to rotate about their own centers. However, as the balls 62 are in a confined volume between the bodies 30A and 30B and the translating member 40, the balls 62 may be loosely disposed in the confined volume, i.e., without any ring 61. Such an embodiment would entail having sufficient balls 62 to avoid large voids between adjacent balls, for example as a result of gravity. In another embodiment, there is only one ball bearing 60, or one level of balls 62, instead of the two levels shown in the figures. In such an embodiment, the translating member 40 may be in sliding contact with the housing 30, for instance by providing low-friction wear pads. In an embodiment featuring a single level of the balls 62, the balls 62 are on the lower one of the bodies 30A and 30B, for the balls 62 to support a greater part of the weight. The lower one may receive the most dominant force according to the mounting arrangement, because of gravity. The single level of the balls 62 may be positioned on the side of the joint assembly 20 that receives the most dominant force. Although not shown, the joint assembly 20 may also have a centering mechanism on the ball ring(s) 61, such as by using springs or a compressible O-ring, for instance located between the ball ring 61 and the inner cavity of the housing 30.

Referring to FIGS. 7 and 8, a similar arrangement of the joint assembly 20 is shown, but in which part of the rotational joint member 50, i.e., the rod 51 and possibly the ball 53, are integral with the translating member 40. FIG. 6 shows an integral construction of the rod 51 with the translating member 40 but this may only be because of the simplification of the figure (rod 51 and ball 53 shown schematically), and hence they may be detachable. In an integral construction, the translating member 40 does not have a central bore 42, and likewise the body 30A of the housing 30 may not have a collar 33A and/or bore to the collar 33A. Like components in the joint assembly 20 of FIGS. 3-6 and in the joint assembly of FIGS. 7 and 8 bear like reference numerals.

Therefore, the translating member 40 may move in a two translational DOFs relative to the housing 30, i.e., in the plane incorporating the X,Y axes or parallel to a plane incoporating the X,Y axes. The surface of the depressions 31 and of the plate body 41, configured for rolling contact with the balls 62 of the ball bearings 60, are therefore also planar, and parallel to the plane incorporating the X,Y axes (the X,Y axes being fixed to the housing 30). The longitudinal axis of the rod 51 or 54 connected to the translating member 40, may be normal to the plane of the X,Y axes. The longitudinal axis of the rod 51 or 54 may also be at a non-normal angle relative to the plane parallel to the X,Y axes. The bearing 60 is therefore incorporated in a section delimited by the planes of the depressions 31 in an embodiment.

Modifications and improvements to the above-described embodiments of the present invention may become apparent to those skilled in the art. The foregoing description is intended to be exemplary rather than limiting. The scope of the present invention is therefore intended to be limited solely by the scope of the appended claims. For instance, the joint assembly 20 need not be part of a motion simulator, and may interconnect two components that are not actuated. The expression spherical joint is used to suggest that at least one rotational degree of freedom may be present, although more degrees of freedom may be present.

1. A joint assembly comprising:
a rotational joint member configured to be connected to a first component;
a housing configured to be connected to a second component or ground and defining an inner cavity;
a translating member received in the inner cavity of the housing and connected to the rotational joint member for concurrent translation relative to the housing; and
at least one level of balls in the inner cavity between a housing surface and a surface of the translating member to support the translation of the translating member in the housing.

2. The joint assembly according to claim 1, wherein the housing has at least a first body and a second body, at least one of the bodies having a depression to form at least part of the inner cavity.

3. The joint assembly according to claim 2, wherein each of the bodies has one of the depression.

4. The joint assembly according to claim 2, wherein the depression is annular.

5. The joint assembly according to claim 2, wherein the first body has a collar projecting into the inner cavity, the collar forming a central bore for accessing the translating member via an exterior of the housing.

6. The joint assembly according to claim 5, wherein the rotational joint member has a rod connected to the translating member and projecting out of the housing via a central bore in the second body.

7. (canceled)

8. The joint assembly according to claim 2, wherein the first body and the second body have pairs of tapped hole and fastener hole for receiving fasteners to secure the first body and the second body to one another.

9. (canceled)

10. The joint assembly according to claim 2, further comprising at least one throughbore extending through the housing and adapted to receive a fastener for securing the housing to the second component or ground.

11. The joint assembly according to claim 1, wherein the translating member has a plate body received in the housing, the plate body defining said surface of the translating member.

12. (canceled)

13. The joint assembly according to claim 11, wherein the plate body has a peripheral flange.

14. The joint assembly according to claim 1, further comprising at least three biasing assemblies in the inner cavity, the biasing assemblies each exerting a combined force oriented to toward a center of the housing on the translating member.

15. The joint assembly according to claim 14, wherein the biasing assemblies are equidistantly distributed in the housing.

16. The joint assembly according to claim 14, wherein the biasing assemblies each include a spring and a ball.

17. The joint assembly according to claim 14, wherein the biasing assemblies are each received in a respective slot in the housing.

18. (canceled)

19. The joint assembly according to claim 1, comprising two of said levels of balls, with a first of said levels of balls between a first of the housing surface and a first of the surface of the translating member, and with a second of said levels of balls between a second of the housing surface and a second of the surface of the translating member.

20. The joint assembly according to claim 1, wherein the level of balls is a ball bearing including a plurality of balls and a ring holding the balls.

21. The joint assembly according to claim 1, wherein the rotational joint member is a spherical joint.

22. The joint assembly according to claim 21, wherein the spherical joint has a ball immovably connected to the translating member by a rod extending from the translating member in the inner cavity to the ball.

23. The joint assembly according to claim 22, wherein an axis of the rod being normal to a plane of translation of the translating member.

24. The joint assembly according to claim 21, further including a spherical joint housing operatingly connected to the ball for forming said spherical joint.

25.-27. (canceled)
